(19) United States
(12) Patent Application Publication
(10) Pub. No.: US 2025/0263005 A1
(43) Pub. Date: Aug. 21, 2025

(54) PORTABLE FOOD CONCESSION VEHICLE

(71) Applicant: Hitch-Hiker Mfg., Inc., New Middleton, OH (US)

(72) Inventor: Jeffrey Mark SWARTZ, New Middletown, OH (US)

(73) Assignee: Hitch-Hiker Mfg., Inc., New Middleton, OH (US)

(21) Appl. No.: 19/053,661

(22) Filed: Feb. 14, 2025

Related U.S. Application Data
(60) Provisional application No. 63/553,922, filed on Feb. 15, 2024.

(51) Int. Cl. B60P 3/025; E04B 1/344; G09F 9/33; G09F 21/04

(52) U.S. Cl. CPC B60P 3/0257; E04B 1/3444; G09F 9/33; G09F 21/048

(57) ABSTRACT

PORTABLE FOOD CONCESSION VEHICLE

A portable food concession vehicle may include one or more LED display screens and one or more awnings. Each awning may be adjustable into: (a) a first condition where it is positioned so that the corresponding LED display screen is visible to customers; and (b) a second condition where it is positioned to cover the corresponding LED display screen.

This patent application claims priority to U.S. Provisional Patent Application No. 63/553,922, filed Feb. 15, 2024, titled PORTABLE FOOD CONCESSION VEHICLE, which is incorporated herein by reference.

### I. BACKGROUND

### A. Field of the Invention

This invention generally relates to apparatuses and methods concerning food concession vehicles having awnings and LED display screens.

### B. Description of Related Art

Food concession vehicles are well known. Portable food concession trailers, for example, have for many years been transported to various events such as fairs, sports games, business locations during lunch and the like. At the completion of one event, the food concession vehicle can easily be transported to another event and/or location. The operators of food concession vehicles typically wish to advertise their products to visitors of the vehicle. As a result, food concession vehicles often include various types of advertising surfaces. In general, advertising surfaces are more effective when they incorporate animated images. Thus, in recent years LED display screens are often used on food concession vehicles.

FIG. 1 shows a known food concession trailer 10 having service stations 12 to serve customers. Above the service stations 12 is an awning 14. An adjustment mechanism 16 may be used to raise and lower the awning 14 and to support the awning 14 in the raised position. The outer edge of the awning 14 has a downward extending vertical surface 18 that serves as an advertising surface (“CARAMEL APPLES”, “CANDY APPLES” and the like are shown). While such known advertising surfaces are useful, they lack the pizazz that current advertising requires, such as LED display screens. In fact, known advertising surfaces on the outer edge of an awning, such as surface 18, are incapable of supporting the types/sizes of LED display screens desired.

What is needed is a food concession vehicle that uses LED display screens and an awning that can be adjusted into a first condition where it permits the LED display screens to be visible to customers and into a second condition where it covers the LED display screens to protect them.

### II. SUMMARY

According to some embodiments of this invention, a portable food concession vehicle may include: a frame; at least two ground engaging wheels rotatably mounted to the frame and selectively operable to move the portable food concession vehicle along an associated ground surface; a first service station: 1) supported to the frame; and 2) forming an opening designed to serve associated food and/or beverages from inside the portable food concession vehicle to associated customers outside the portable food concession vehicle; a first LED display screen: 1) supported to the frame; and 2) having a display planar surface area of at least 6 square feet; a first awning: 1) supported to the frame; and 2) selectively adjustable into: (a) a first condition where the first awning is positioned so that the first LED display screen is visible to the associated customers outside the portable food concession vehicle; and (b) a second condition where the first awning is positioned to cover the first LED display screen.

According to some embodiments of this invention, a portable food concession vehicle may include: a frame; at least two ground engaging wheels rotatably mounted to the frame and selectively operable to move the portable food concession vehicle along an associated ground surface; a first service station: 1) supported to the frame; and 2) forming an opening designed to serve associated food and/or beverages from inside the portable food concession vehicle to associated customers outside the portable food concession vehicle; a second service station: 1) supported to the frame; and 2) forming an opening designed to serve associated food and/or beverages from inside the portable food concession vehicle to the associated customers outside the portable food concession vehicle; a first LED display screen: 1) supported to the frame; and 2) having a display planar surface area of at least 6 square feet; a second LED display screen: 1) supported to the frame; and 2) having a display planar surface area of at least 6 square feet; a first awning: 1) supported to the frame; and 2) selectively adjustable into: (a) a first condition where the first awning is positioned so that the first LED display screen is visible to the associated customers outside the portable food concession vehicle; and (b) a second condition where the first awning is positioned to cover the first LED display screen; a second awning: 1) supported to the frame; and 2) selectively adjustable into: (a) a first condition where the second awning is positioned so that the second LED display screen is visible to the associated customers outside the portable food concession vehicle; and (b) a second condition where the second awning is positioned to cover the second LED display screen. When the first awning is in the first condition the first awning may be positioned overhead to at least partially protect the associated customers outside the portable food concession vehicle from sun and/or rain. When the second awning is in the first condition the second awning may be positioned overhead to at least partially protect the associated customers outside the portable food concession vehicle from sun and/or rain. When the first awning is in the second condition the first awning may be positioned to cover the opening in the first service station surface. When the second awning is in the second condition the second awning may be positioned to cover the opening in the second service station. A lighting control system may be selectively operable to create a continuous image simultaneously using the first and second LED display screens.

According to some embodiments of this invention, a portable food concession vehicle method may include the steps of: A) providing a portable food concession vehicle including: 1) a frame; 2) at least two ground engaging wheels rotatably mounted to the frame; 3) a first service station: (a) supported to the frame; and (b) forming an opening; 4) a second service station: (a) supported to the frame; and (b) forming an opening; 5) a first LED display screen: (a) supported to the frame; and (b) having a display planar surface area of at least 6 square feet; 6) a second LED display screen: (a) supported to the frame; and (b) having a display planar surface area of at least 6 square feet; 7) a first awning supported to the frame; 8) a second awning supported to the frame; and 9) a lighting control system; B) providing the at least two ground engaging wheels to be selectively operable to move the portable food concession vehicle along an associated ground surface; C) providing the opening in the first service station to be selectively operable to serve associated food and/or beverages from inside the portable food concession vehicle to associated customers outside the portable food concession vehicle; D) providing the opening in the second service station to be selectively operable to serve associated food and/or beverages from inside the portable food concession vehicle to associated customers outside the portable food concession vehicle; E) providing the first awning to be selectively adjustable into: 1) a first condition where the first awning is positioned: (a) so that the first LED display screen is visible to the associated customers outside the portable food concession vehicle; and (b) overhead to at least partially protect the associated customers outside the portable food concession vehicle from sun and/or rain; and 2) a second condition where the first awning is positioned: (a) to cover the first LED display screen; and (b) to cover the opening in the first service station; F) providing the second awning to be selectively adjustable into: 1) a first condition where the second awning is positioned: (a) so that the second LED display screen is visible to the associated customers outside the portable food concession vehicle; and (b) overhead to at least partially protect the associated customers outside the portable food concession vehicle from sun and/or rain; and 2) a second condition where the second awning is positioned: (a) to cover the second LED display screen; and (b) to cover the opening in the second service station; and G) providing the lighting control system to be selectively operable to create a continuous image simultaneously using the first and second LED display screens.

### III. Brief Description of the Drawings

The invention may take physical form in certain parts and arrangement of parts, embodiments of which will be described in detail in this specification and illustrated in the accompanying drawings which form a part hereof and wherein:

FIG. 1 is a front view of a known portable food concession trailer.

FIG. 2 is a front perspective view of a portable food concession vehicle according to some embodiments of this invention.

FIG. 3 is an end view, shown partially in cutaway, of the portable food concession vehicle shown in FIG. 2.

FIG. 4 is an end view, shown in cutaway, of the portable food concession vehicle shown in FIG. 2.

FIG. 5A is a side view of an LED display screen according to some embodiments of this invention.

FIG. 5A is a side view of the LED display screen shown in FIG. 5A but with a door opened to reveal components hidden in FIG. 5A.

FIG. 6 is a top view illustrating certain components of the portable food concession vehicle shown in FIG. 2.

FIG. 7 is a corner perspective view of a portable food concession vehicle according to some embodiments of this invention.

FIG. 8 is a perspective end view of the portable food concession vehicle shown in FIG. 7.

FIG. 9 is a corner perspective end view of the portable food concession vehicle shown in FIG. 7 but with the visible awnings in the second condition.

FIG. 10 is a close-up view of a portion of the portable food concession vehicle shown in FIG. 8.

FIG. 11 shows details of a portable food concession vehicle with an awning in the first condition according to some embodiments of this invention.

FIG. 12 shows details of the portable food concession vehicle shown in FIG. 11 but with the awning in the second condition according to some embodiments of this invention.

FIG. 13 shows a corner awning component according to some embodiments of this invention.

FIGS. 14A-14H illustrate, sequentially, how an operator may adjust an awning from the second condition to the first condition.

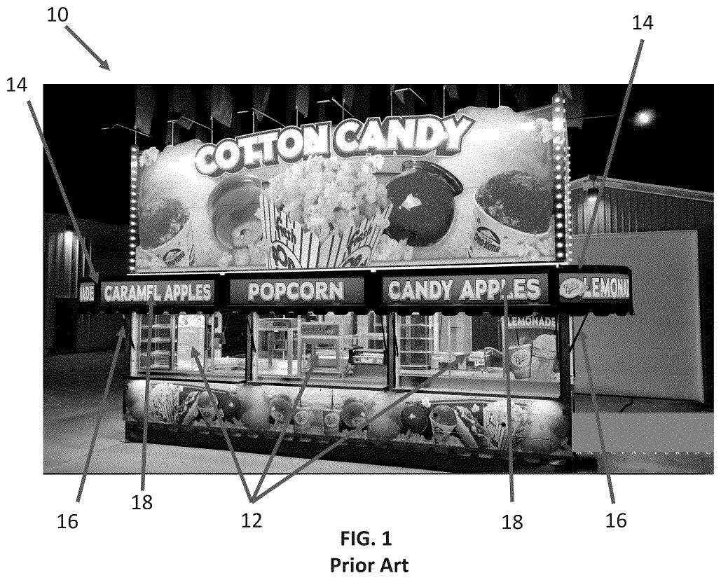

### IV. Detailed Description

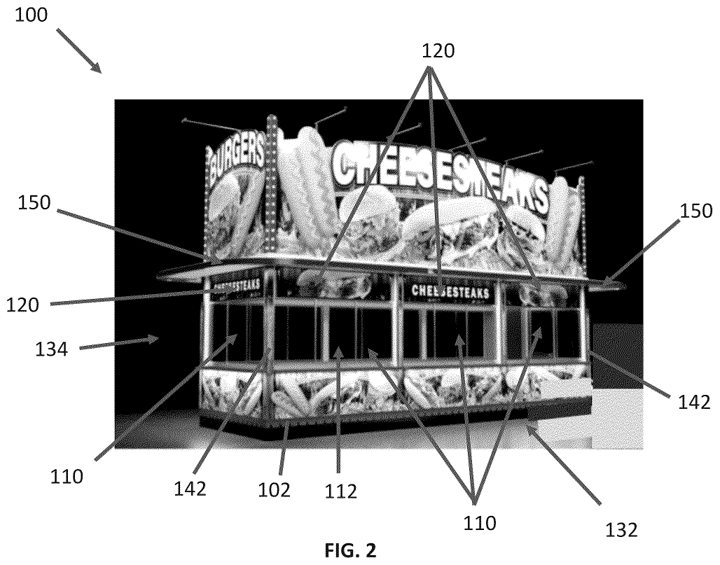

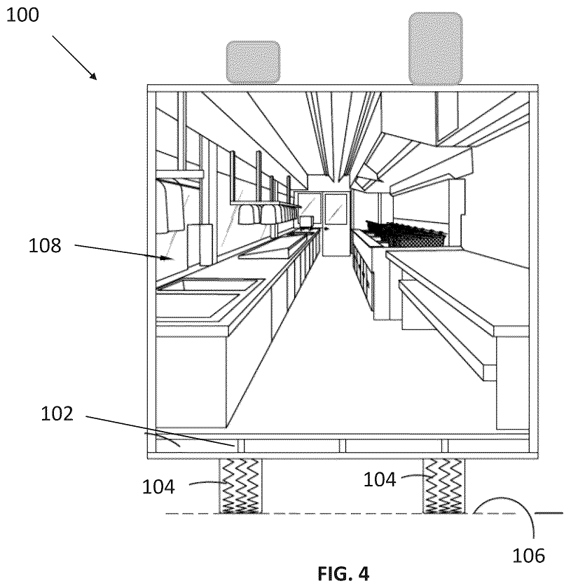

Referring now to the drawings wherein the showings are for purposes of illustrating embodiments of the invention only and not for purposes of limiting the same, and wherein like reference numerals are understood to refer to like components, FIGS. 2-4 show a food concession trailer 100 according to some embodiments of this invention. It should be noted that while the shown food concession trailer is transported by a truck (not shown) from place to place, this invention will work well with any food concession vehicle chosen with the sound judgement of a person of skill in the art, such as, but not limited to, a food truck. The food concession trailer 100 may have a frame 102 and at least two ground engaging wheels 104 rotatably mounted with respect to the frame 102 and selectively operable to move the portable food concession trailer 100 along a ground surface 106. The food concession trailer 100 may have, as shown in FIG. 4, a food processing area (more accurately, a food processing “volume” as well known to a person of skill in the art) 108 supported to the frame 102 that may include any food and/or beverage preparation and service components required. U.S. patent application Ser. No. 18/054,772, titled PORTABLE FOOD CONCESSION TRAILER, which is incorporated by reference herein in its entirety, provides examples of food and/or beverage preparation and service components that would work well with this invention. In some embodiments, to insure top quality, the equipment in the food processing area 108 is NSF certified. The food concession trailer 100 may include one or more service stations 110 each having the ability to form an opening 112, such as by sliding a glass/plastic panel, to serve food and/or beverages from inside the portable food concession trailer to customers outside the portable food concession vehicle, as is well known.

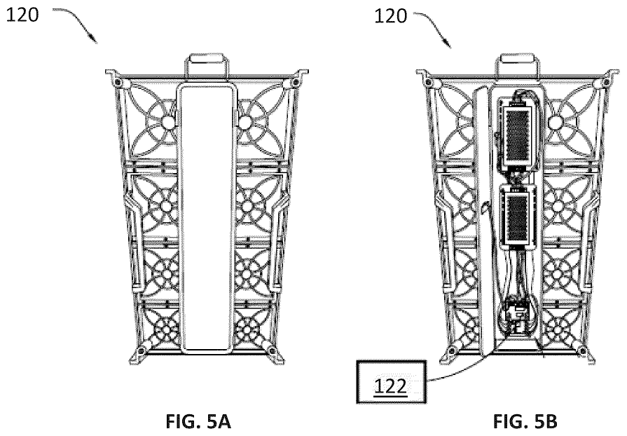

With reference now to FIGS. 2, 5A and 5B, the portable food concession trailer 100 may have one or more LED display screens 120 supported to the frame 102 that may be used as an advertising surface(s). The LED display screens 120 used with this invention can be of any type chosen with the sound judgment of a person of skill in the art that have a display planar surfaces area of at least 6 square feet. In some embodiments, the LED display screens 120 may be formed from one or more LED panels, as shown in FIGS. 5A and 5B. A lighting control system 122, which can be of any type chosen with the sound judgement of a person of skill in the art, can be operated in a known manner to provide the desired display on the LED display screens 120. In some embodiments, the lighting control system 122 system is selectively operable to create a continuous image simultaneously using the multiple LED display screens 120. In some embodiments, the lighting control system 122 system is selectively operable to create a continuous image simultaneously using all the LED display screens 120 provided on the portable food concession vehicle.

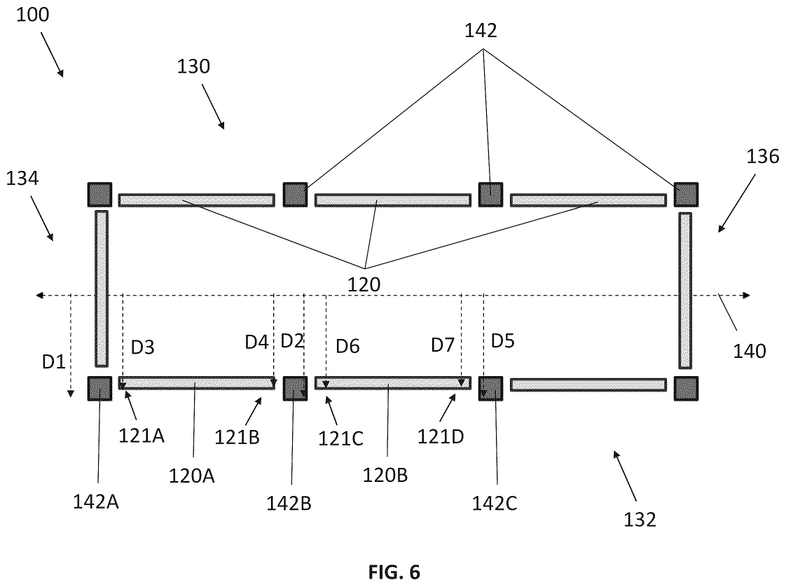

With reference now to FIGS. 2 and 6, the LED display screens 120 may be positioned on the portable food concession vehicle in any locations chosen with the sound judgement of a person of skill in the art. In some embodiments, as shown in FIG. 2, the LED display screens 120 may be positioned vertically above the openings 112 in the service stations 110. FIG. 6 illustrates, from a top view, certain components of the portable food concession trailer 100 shown in FIG. 2. Specifically, the portable food concession trailer 100 has four planar walls, including a pair of sides 130, 132, and a pair of ends 134, 136, and a longitudinal axis 140. Other sizes and shapes for a portable food concession vehicle may also work well with this invention. The frame 120, in this embodiment, includes eight vertical columns 142, four on each side 130, 132 and two on each end 134, 136. The portable food concession trailer 100 shown has three LED display screens 120 on each side 130, 132 and one LED display screens 120 on each end 134, 136. Wall 132 may include vertical columns 142A, 142B and 142C longitudinally spaced from each other and each having an outer surface spaced from the longitudinally axis 140 a maximum distance D1, D2 and D5, respectively. LED display screen 120A may be positioned on wall 132 between vertical columns 142A and 142B and LED display screen 120B may be positioned on wall 132 between vertical columns 142B and 142C. LED display screen 120A may have an outer surface with a first end 121A juxtaposed to vertical column 142A and spaced from the longitudinal axis a maximum distance D3 and a second end 121B juxtaposed to vertical column 142B and spaced from the longitudinal axis a maximum distance D4. LED display screen 120B may have an outer surface with a first end 121C juxtaposed to vertical column 142B and spaced from the longitudinal axis a maximum distance D6 and a second end 121D juxtaposed to vertical column 142C and spaced from the longitudinal axis a maximum distance D7. In some embodiments, D3 is within 5 inches of D1, D4 is within 5 inches of D2, D6 is within 5 inches of D2 and D7 is within 5 inches of D5. In some embodiments D3<D1, D4<D2, D6<D2 and D7<D5. The other vertical columns 142 and LED display screens 120 may be similarly positioned. For the embodiments shown, the portable food concession trailer 100 has three service stations 110 on each side 130, 132 and one service station 110 on each end 134, 136 but the particular arrangement may be any chosen with the sound judgement of a person of skill in the art.

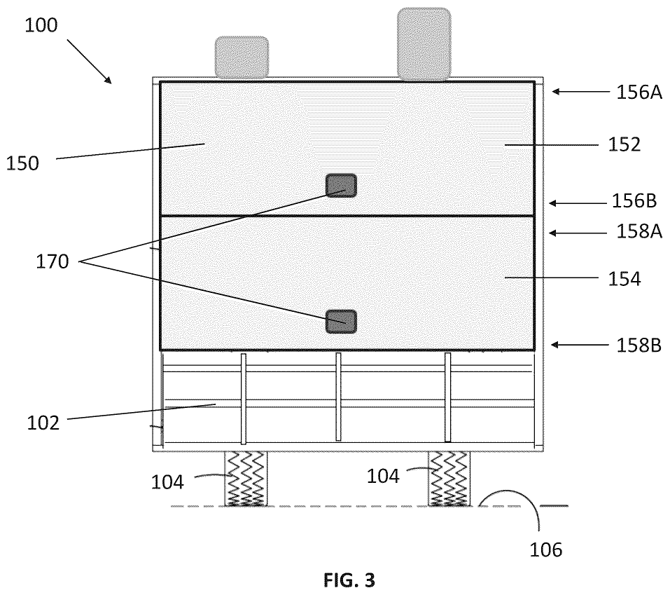

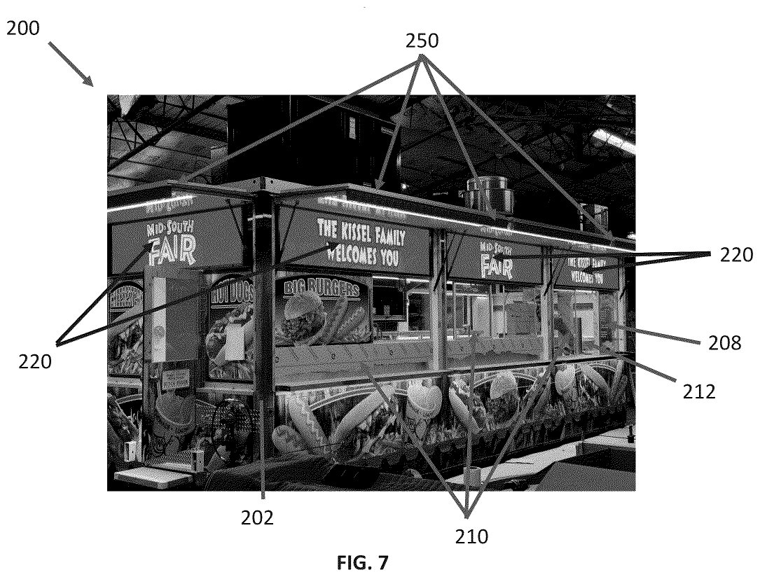

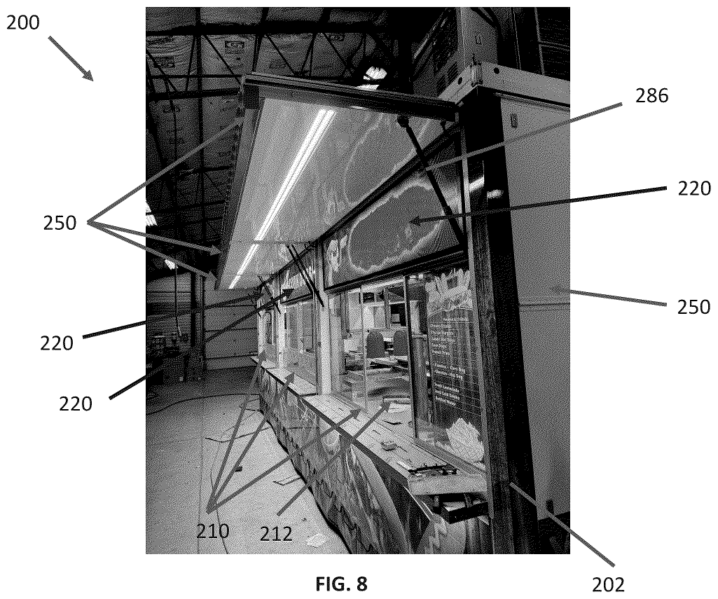

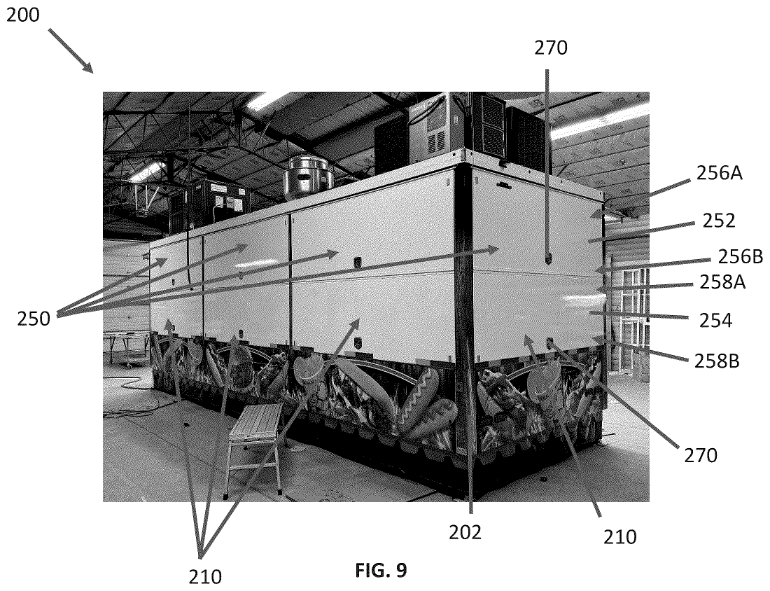

As shown in FIGS. 2-3, the portable food concession trailer 100 may have one or more awnings 150 supported to the frame 102. To better understand the operation and various embodiments of the awnings of this invention, consider now FIGS. 7-9 which show a food concession vehicle 200, in the form of a trailer, according to some embodiments of this invention. As with portable food concession trailer 100, portable food concession trailer 200 may have a frame 202, at least two ground engaging wheels (not visible), a food processing area 208, one or more service stations 210 each having the ability to form an opening 212, and one or more LED display screens 220. Since these components are similar to those discussed above regarding the portable food concession trailer 100, details will not be provided here. Awnings 250 are supported to the frame 202 and can be selectively adjusted into two conditions. In a first condition, an awning 150, 250 is positioned so that a juxtaposed LED display screen 120, 220 is visible to the customers outside the portable food concession vehicle 100, 200. For the embodiments shown, the juxtaposed LED display screens 120, 220 are positioned vertically below the corresponding awnings 150, 250. In a second condition, an awning 150, 250 is positioned so that a juxtaposed LED display screen 120, 220 is covered. A covered display screen 120, 220 is protected from damage. One non-limiting example of when it is beneficial to cover/protect a display screen 120, 220 is when the portable food concession vehicle 200 is being moved along a ground surface. All four of the awnings 250 visible in FIG. 7 are in the first condition and all four of the awnings 250 visible in FIG. 9 are in the second condition. In FIG. 8, the three awnings 250 visible on the left side (in this figure) are in the first condition and the awning 250 only partially visible on the end of the portable food concession vehicle 200 (on the right side in this figure) is in the second condition. In some embodiments, also shown in FIGS. 2 and 7-9, when the awning 150, 250 is in the first condition it is also positioned overhead to at least partially protect the customers outside the portable food concession vehicle from sun and/or rain and when the awning 150, 250 is in the second condition it is also positioned to cover the corresponding opening 112, 212 in the corresponding service station 110, 210. For the embodiments shown, the juxtaposed openings 112, 212 are positioned vertically below the corresponding awnings 150, 250.

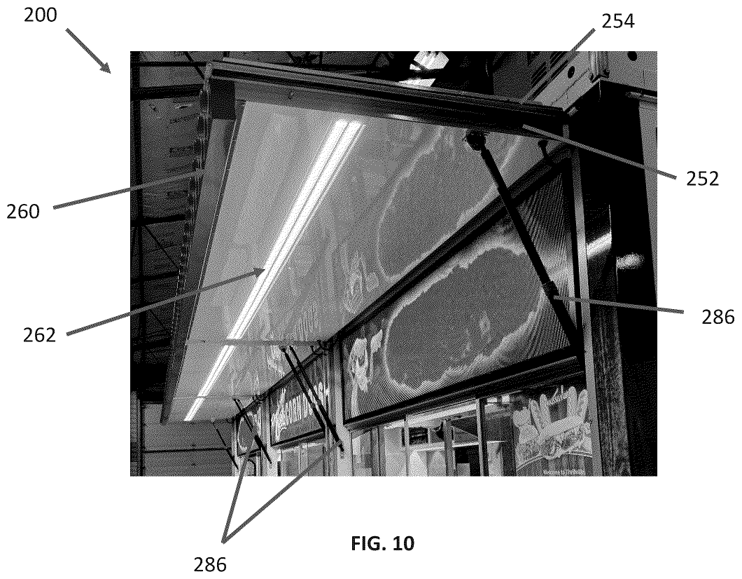

With reference now to FIGS. 2-3 and 7-10, in some embodiments an awning 150, 250 may include a first awning portion 152, 252 and a second awning portion 154, 254, respectively. The first awning portions 152, 252 may have first sides 156A, 256A and second sides 156B, 256B, respectively, and the second awning portions 154, 254 may have first sides 158A, 258A and second sides 158B, 258B, respectively. The first sides 156A, 256A of the first awning portions 152, 252 may be pivotally attached to the frame 102, 202 and the first sides 158A, 258A of the second awning portions 154, 254 may be pivotally attached to the second sides 156B, 256B of the first awning portions 152, 252. With this arrangement the second awning portions 154, 254 can be folded with respect to the first awning portions 152, 252. For the embodiments shown, the second awning portions 154, 254 can be folded onto to the first awning portions 152, 252. In some embodiments, as shown, this folded design is preferred when the awning 150, 250 is in the first condition. In some embodiments, the second sides second sides 256B of the first awning portions 252 may have a decorative object 260 sized and shaped as desired (a decorative object is also shown in FIG. 2). In some embodiments, the decorative object 260 may be a light, such as an LED light. In some embodiments, shown, the first awning portions 252 may have a light 262 to assist the customers outside the portable food concession vehicle. In some embodiments, the awnings 150, 250 may have a locking mechanism 170, 270. In some embodiments, shown, each awning portion 152, 154, 252, 254 may have a locking mechanism 170, 270. The locking mechanisms may be used to lock the awnings 150, 250 into the second conditions onto the portable food concession vehicle. The locking mechanisms 170, 270 can also be unlocked to permit the awnings 150, 250 to be adjusted into the first conditions.

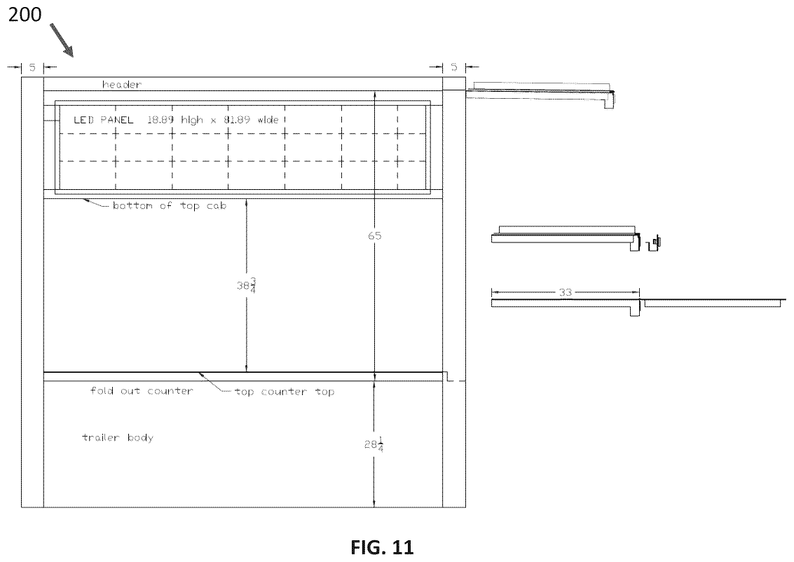

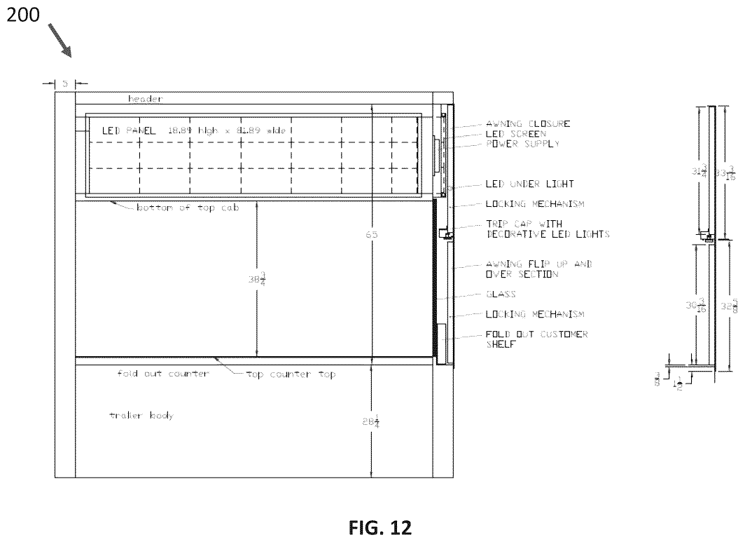

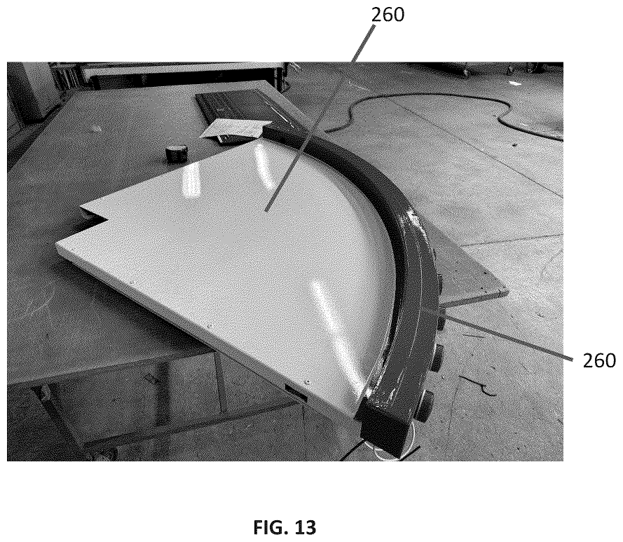

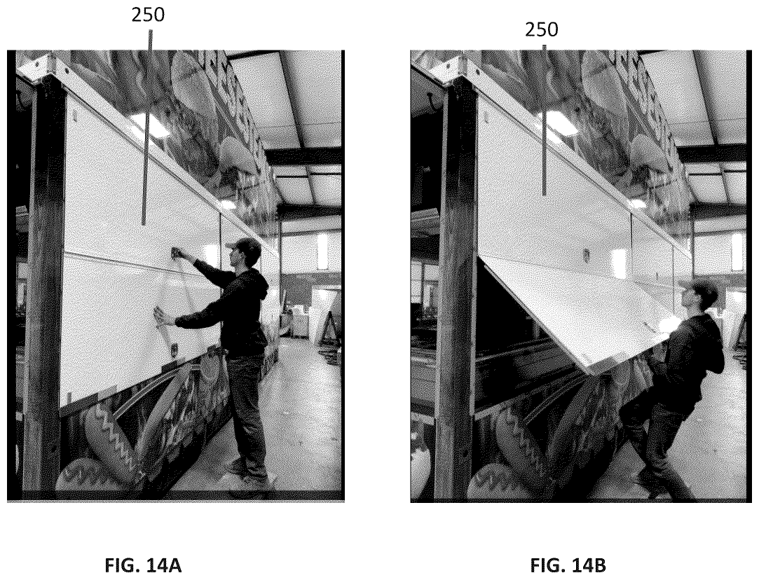

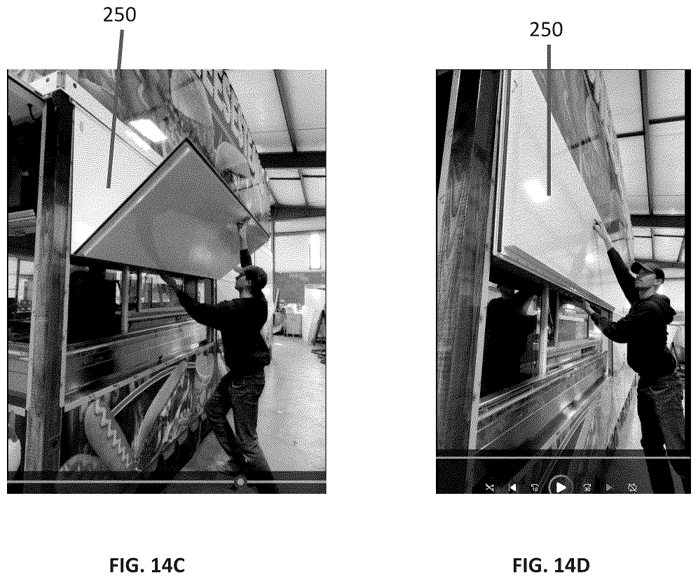

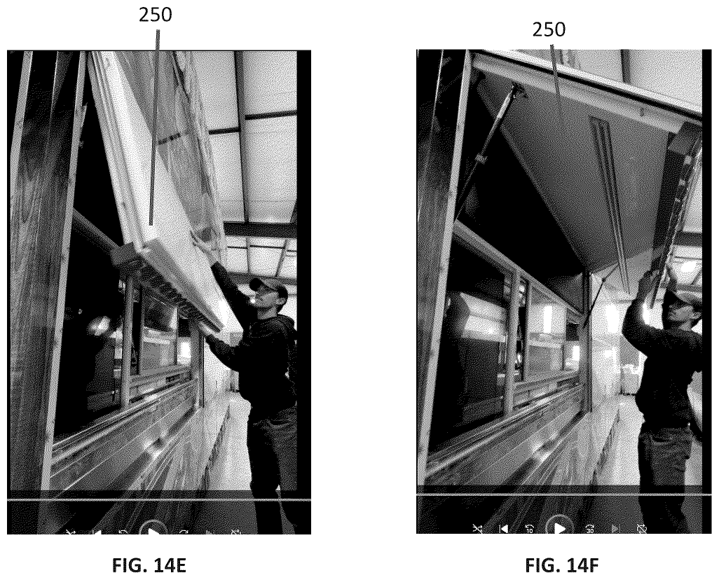

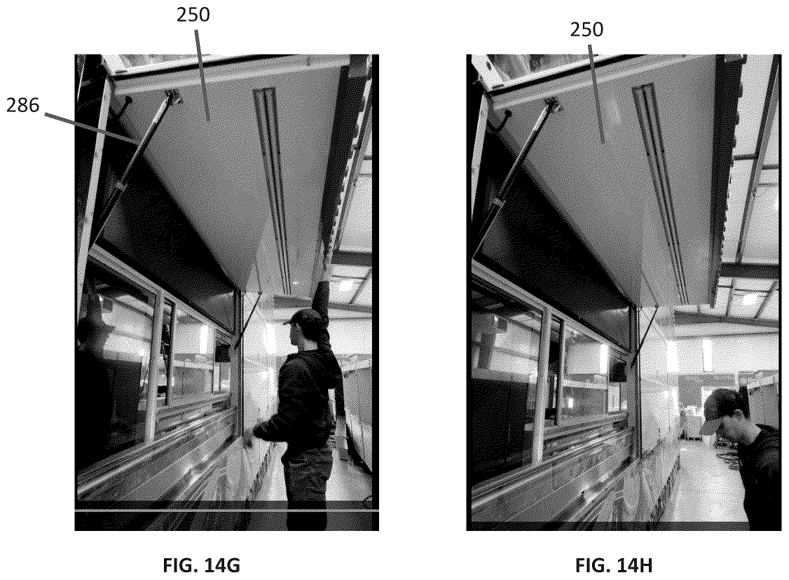

FIG. 11 shows details of the portable food concession vehicle 200 with an awning in the first condition according to some embodiments of this invention. FIG. 12 shows details of the portable food concession vehicle 200 with an awning in the second condition according to some embodiments of this invention. FIG. 13 shows a corner awning component 280 according to some embodiments of this invention. A corner awning component 280 may be attached to each corner of the food concession vehicle 200 after the juxtaposed awnings 250 on the planar walls have been adjusted into the first conditions. The corner awning component 280 may have a decorative object 260 to match the decorative objects 260 used on the juxtaposed awnings 250. Corner awning components are shown in FIG. 2. FIGS. 14A-14H illustrate, sequentially, how an operator may adjust awning 250 from the second condition to the first condition. In some embodiments, gas assisted springs 286 may be used to assist with this adjustment. The opposite sequence of steps can be used to adjust awning 250 from the first condition to the second condition.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the patent claims or the equivalents thereof. Further, the “invention” as that term is used in this document is what is claimed in the patent claims. The right to claim elements and/or sub-combinations that are disclosed herein as other inventions in other patent documents is hereby unconditionally reserved. When the word “associated” precedes a claim term, it is to be understood that the claim term is NOT being positively claimed; instead such a claim term is simply being referred to understand the application of the other relevant claim terms.

Having thus described the invention, it is now claimed:

I/we claim:

1. A portable food concession vehicle comprising:
a frame;
at least two ground engaging wheels rotatably mounted to the frame and selectively operable to move the portable food concession vehicle along an associated ground surface;
a first service station:
supported to the frame; and
forming an opening designed to serve associated food and/or beverages from inside the portable food concession vehicle to associated customers outside the portable food concession vehicle;
a first LED display screen:
1) supported to the frame; and
2) having a display planar surface area of at least 6 square feet;
a first awning:
1) supported to the frame; and
2) selectively adjustable into:
(a) a first condition where the first awning is positioned so that the first LED display screen is visible to the associated customers outside the portable food concession vehicle; and
(b) a second condition where the first awning is positioned to cover the first LED display screen.

2. The portable food concession vehicle of claim 1 wherein:
when the first awning is in the first condition the first awning is positioned overhead to at least partially protect the associated customers outside the portable food concession vehicle from sun and/or rain.

3. The portable food concession vehicle of claim 1 wherein:
when the first awning is in the second condition the first awning is positioned to cover the opening in the first service station.

4. The portable food concession vehicle of claim 1 wherein:
the portable food concession vehicle has a longitudinal axis;
the frame includes a first vertical column positioned on a first wall and having an outer surface spaced from the longitudinal axis a maximum distance D1;
the frame includes a second vertical column positioned on the first wall longitudinally spaced from the first vertical column and having an outer surface spaced from the longitudinal axis a maximum distance D2;
the first LED display screen is positioned on the first wall between the first and second vertical columns;
the first LED display screen has an outer surface with a first end juxtaposed to the first vertical column and spaced from the longitudinal axis a maximum distance D3;
the outer surface of the first LED display screen has a second end juxtaposed to the second vertical column and spaced from the longitudinal axis a maximum distance D4;
D3 is within 5 inches of D1; and
D4 is within 5 inches of D2.

5. The portable food concession vehicle of claim 4 wherein:
D3<D1; and
D4<D2.

6. The portable food concession vehicle of claim 1 wherein:
the first awning has a first awning portion having a first side and a second side;
the first awning has a second awning portion having a first side and a second side;
the first side of the first awning portion is pivotally attached to the frame;
the first side of the second awning portion is pivotally attached to the second side of the first awning portion; and
when the first awning is in the first condition, the second awning portion is folded onto the first awning portion.

7. The portable food concession vehicle of claim 1 wherein:
the portable food concession vehicle is a portable food concession trailer; and
the first LED display screen is positioned vertically above the opening in the first service station.

8. The portable food concession vehicle of claim 1 further comprising:
a second LED display screen:
supported to the frame; and
having a display planar surface area of at least 6 square feet;
a second awning:
1) supported to the frame; and
2) selectively adjustable into:
(a) a first condition where the second awning is positioned so that the second LED display screen is visible to the associated customers outside the portable food concession vehicle; and
(b) a second condition where the second awning is positioned to cover the second LED display screen;
wherein a lighting control system is selectively operable to create a continuous image simultaneously using the first and second LED display screens.

9. A portable food concession vehicle comprising:
a frame;
at least two ground engaging wheels rotatably mounted to the frame and selectively operable to move the portable food concession vehicle along an associated ground surface;
a first service station:
1) supported to the frame; and
2) forming an opening designed to serve associated food and/or beverages from inside the portable food concession vehicle to associated customers outside the portable food concession vehicle;
a second service station:
1) supported to the frame; and
2) forming an opening designed to serve associated food and/or beverages from inside the portable food concession vehicle to the associated customers outside the portable food concession vehicle;
a first LED display screen:
supported to the frame; and
having a display planar surface area of at least 6 square feet;
a second LED display screen:
1) supported to the frame; and
2) having a display planar surface area of at least 6 square feet;
a first awning:
1) supported to the frame; and
2) selectively adjustable into:
(a) a first condition where the first awning is positioned so that the first LED display screen is visible to the associated customers outside the portable food concession vehicle; and
(b) a second condition where the first awning is positioned to cover the first LED display screen;
a second awning:
1) supported to the frame; and
2) selectively adjustable into:
(a) a first condition where the second awning is positioned so that the second LED display screen is visible to the associated customers outside the portable food concession vehicle; and
(b) a second condition where the second awning is positioned to cover the second LED display screen;
wherein:
1) when the first awning is in the first condition the first awning is positioned overhead to at least partially protect the associated customers outside the portable food concession vehicle from sun and/or rain;
2) when the second awning is in the first condition the second awning is positioned overhead to at least partially protect the associated customers outside the portable food concession vehicle from sun and/or rain;
3) when the first awning is in the second condition the first awning is positioned to cover the opening in the first service station surface;
4) when the second awning is in the second condition the second awning is positioned to cover the opening in the second service station; and
5) a lighting control system is selectively operable to create a continuous image simultaneously using the first and second LED display screens.

10. The portable food concession vehicle of claim 9 wherein:
the portable food concession vehicle has a longitudinal axis;
the frame includes a first vertical column positioned on a first wall and having an outer surface spaced from the longitudinal axis a maximum distance D1;
the frame includes a second vertical column positioned on the first wall longitudinally spaced from the first vertical column and having an outer surface spaced from the longitudinal axis a maximum distance D2;
the first LED display screen is positioned on the first wall between the first and second vertical columns;
the first LED display screen has an outer surface with a first end juxtaposed to the first vertical column and spaced from the longitudinal axis a maximum distance D3;
the outer surface of the first LED display screen has a second end juxtaposed to the second vertical column and spaced from the longitudinal axis a maximum distance D4;
D3 is within 5 inches of D1; and
D4 is within 5 inches of D2.

11. The portable food concession vehicle of claim 10 wherein:
D3<D1; and
D4<D2.

12. The portable food concession vehicle of claim 10 wherein:
the frame includes a third vertical column positioned on the first wall longitudinally spaced from the first and second vertical columns and having an outer surface spaced from the longitudinal axis a maximum distance D5;
the second LED display screen is positioned on the first wall between the second and third vertical columns;
the second LED display screen has an outer surface with a first end juxtaposed to the second vertical column and spaced from the longitudinal axis a maximum distance D6;
the outer surface of the second LED display screen has a second end juxtaposed to the third vertical column and spaced from the longitudinal axis a maximum distance D7;
D6 is within 5 inches of D2; and
D7 is within 5 inches of D5.

13. The portable food concession vehicle of claim 12 wherein:
D6<D2; and
D7<D5.

14. The portable food concession vehicle of claim 9 wherein:
each of the first and second awnings has:
1) a first awning portion having a first side and a second side; and
2) a second awning portion having a first side and a second side;
each of the first sides of the first awning portions are pivotally attached to the frame;
each of the first sides of the second awning portions are pivotally attached to the corresponding second sides of the first awning portions;
when the first awning is in the first condition, the second awning portion of the first awning is folded onto the first awning portion of the first awning; and
when the second awning is in the first condition, the second awning portion of the second awning is folded onto the first awning portion of the second awning.

15. The portable food concession vehicle of claim 9 wherein:
the portable food concession vehicle is a portable food concession trailer;
the first LED display screen is positioned vertically above the opening in the first service station; and
the second LED display screen is positioned vertically above the opening in the second service station.

16. A portable food concession vehicle method comprising the steps of:
A) providing a portable food concession vehicle including:
1) a frame;
2) at least two ground engaging wheels rotatably mounted to the frame;
3) a first service station:
(a) supported to the frame; and
(b) forming an opening;
4) a second service station:
(a) supported to the frame; and
(b) forming an opening;
5) a first LED display screen:
(a) supported to the frame; and
(b) having a display planar surface area of at least 6 square feet;
6) a second LED display screen:
(a) supported to the frame; and
(b) having a display planar surface area of at least 6 square feet;
7) a first awning supported to the frame;
8) a second awning supported to the frame; and
9) a lighting control system;
B) providing the at least two ground engaging wheels to be selectively operable to move the portable food concession vehicle along an associated ground surface;
C) providing the opening in the first service station to be selectively operable to serve associated food and/or beverages from inside the portable food concession vehicle to associated customers outside the portable food concession vehicle;
D) providing the opening in the second service station to be selectively operable to serve associated food and/or beverages from inside the portable food concession vehicle to associated customers outside the portable food concession vehicle;
E) providing the first awning to be selectively adjustable into:
1) a first condition where the first awning is positioned:
(a) so that the first LED display screen is visible to the associated customers outside the portable food concession vehicle; and
(b) overhead to at least partially protect the associated customers outside the portable food concession vehicle from sun and/or rain; and
2) a second condition where the first awning is positioned:
(a) to cover the first LED display screen; and
(b) to cover the opening in the first service station;
F) providing the second awning to be selectively adjustable into:
1) a first condition where the second awning is positioned:
(a) so that the second LED display screen is visible to the associated customers outside the portable food concession vehicle; and
(b) overhead to at least partially protect the associated customers outside the portable food concession vehicle from sun and/or rain; and
2) a second condition where the second awning is positioned:
(a) to cover the second LED display screen; and
(b) to cover the opening in the second service station; and
G) providing the lighting control system to be selectively operable to create a continuous image simultaneously using the first and second LED display screens.

17. The portable food concession vehicle method of claim 16 wherein:
step A) comprises the steps of:
1) providing each of the first and second awnings with:
(a) a first awning portion having a first side and a second side; and
(b) a second awning portion having a first side and a second side;
2) providing each of the first sides of the first awning portions to be pivotally attached to the frame; and
3) providing each of the first sides of the second awning portions to be pivotally attached to the corresponding second sides of the first awning portions;
when the first awning is in the first condition, the second awning portion of the first awning is folded onto the first awning portion of the first awning; and
when the second awning is in the first condition, the second awning portion of the second awning is folded onto the first awning portion of the second awning.

18. The portable food concession vehicle method of claim 17 further comprising the steps of:
providing the portable food concession vehicle with a pair of distinct sides and a pair of distinct ends; and
positioning the first service station, the second service station, the first LED display screen, the second LED display screen, the first awning and the second awning on one of the sides of the portable food concession vehicle.

19. The portable food concession vehicle method of claim 17 further comprising the steps of:
providing the portable food concession vehicle with a pair of distinct sides and a pair of distinct ends; and
positioning the first service station, the first LED display screen and the first awning on one of the sides of the portable food concession vehicle; and
positioning the second service station, the second LED display screen and the second awning on one of the ends of the portable food concession vehicle.

20. The portable food concession vehicle method of claim 19 further comprising the steps of:
providing the portable food concession vehicle to be a portable food concession trailer;
positioning the first LED display screen vertically above the opening in the first service station; and
positioning the second LED display screen vertically above the opening in the second service station.
